(19) United States
(12) Patent Application Publication
(10) Pub. No.: US 2022/0248605 A1
(43) Pub. Date: Aug. 11, 2022

(54) MOWER TYPE AGRICULTURAL MACHINE

(71) Applicant: KUHN SAS, Saverne (FR)

(72) Inventor: Joël WILHELM, Saint-Louis (FR)

(73) Assignee: KUHN SAS, Saverne (FR)

(21) Appl. No.: 17/584,622

(22) Filed: Jan. 26, 2022

(30) Foreign Application Priority Data
Feb. 10, 2021 (FR) 21 01267

(51) Int. Cl. A01D 57/20; A01D 34/66; A01D 34/71

(52) U.S. Cl. CPC A01D 57/20; A01D 34/664; A01D 2101/00; A01D 34/71; A01D 34/668

(57) ABSTRACT

The present invention relates to an agricultural machine of the mower type comprising a frame carrying a cutter bar comprising cutting rotors driven in rotation about respective parallel axes and a belt conveyor comprising an endless belt driven in motion and guided between two rollers driven in rotation about their axis, the conveyor being arranged behind the cutter bar to collect the harvest cut and to move it transversely to the direction of advance. The axes of the rollers of the conveyor are substantially parallel to the axes of the cutting rotors, the machine further comprising a collecting shield fastened to the belt conveyor and extending at least partially under the latter and towards the cutter bar while being adjacent to the latter, and a space forming a transverse conveying channel is provided above the collecting shield between the conveying surface of the belt and the cutter bar. The agricultural machine furthermore comprises an upper deflector extending above the cutter bar and above the conveying surface of the belt.

### BACKGROUND OF THE INVENTION

### Field of the Invention

The present invention relates to the field of agricultural machines and more specifically agricultural mowers and its subject is a mower type agricultural machine.

### Description of the Related Art

Mower type agricultural machines make it possible to cut the harvest of plants such as grass or cereals and are generally towed by a tractor vehicle or mounted laterally on the rear or at the front of a tractor vehicle.

These agricultural machines comprise a frame carrying a cutting system formed by a cutter bar extending perpendicular or transversal to the direction of advance of the machine, at least when the latter is in the work configuration. Such a cutter bar often comprises cutting tools of the cutting rotor type, driven in rotation around respective rotor axes parallel to one another.

Mower type agricultural machines are also known with a conveyor mounted at the rear of the cutter bar to collect the harvest cut by the cutter bar and transport it transversally to the direction of advance.

Such a mower type agricultural machine is known from document DE 102012000301, which discloses a conveyor of the auger conveyor-type mounted at the rear of the cutter bar.

However, there are many drawbacks to using auger conveyors on this type of agricultural machine: important weight requiring a heavy connecting structure and a lot of power; downward rotation of the auger implying to drive the harvest in the opposite direction to that generated by the cutting rotors (upward), which generates turbulence in the harvest flow at the rear of the cutter bar and causes part of the harvest to flow back to the front of the rotors, reducing the rotors' cutting quality; while the harvest is rotating around the core of the auger, it is twisted (forming a coil), resulting in difficulties in adjusting the intake of the harvest when being picked up by a machine fitted with a pick-up, such as conventional balers and choppers.

Other known mower type agricultural machines make it possible to solve at least some of the drawbacks of auger conveyors by instead using a belt conveyor and a conditioning device. In this case, the machine comprises a chassis that carries, successively from the front to the rear of the machine in relation to its direction of advance in work configuration, the cutter bar, the conditioning device and the belt conveyor. Such an agricultural machine is known from document EP 0406766.

This document EP 0406766 discloses a mower-conditioner type of machine, comprising a cutter bar of the type with rotary cutter discs and a conveyor with a substantially flat surface and mounted at the rear of the machine to receive and support the harvest (mowed grass) and transport the latter to one side of the machine. The conveyor can swivel around horizontal pivot pins from a work position towards a raised rest position overlooking the work position. The conveyor comprises a transporting element formed by a wide rubber belt reinforced with cross-lath, passing endlessly over end rollers each moved in rotation around an axis. The machine also comprises a conditioning device arranged at the rear of the cutter bar and a cover above the device, arranged such that the harvest cut by the cutter bar is received, coming from the latter, by the conditioning device. In the work position, the conveyor is tilted 10 to 40° from horizontal, such that its rear side is higher than its front side. Therefore, the axes of the end rollers relative to the axes of the cutter discs, which are substantially vertical or slightly tilted forward, are tilted rearward and in particular by more than 45° rearward in a side view.

However, in an agricultural machine of the type disclosed in document EP 0406766, the conditioning device requires a drive system to drive it, making the machine heavier, and longer (in the direction of advance), thus reducing its maneuverability. Furthermore, when such a machine is mounted, such a length also implies a significant cantilever force in the transport configuration. On the other hand, there will be losses of harvest from underneath, between the cutter bar and the conveyor. Lastly, the harvest slips on the conveyor belt and is driven in packets, leading to an irregular swath that might cause jams while picking up, as well as harvest remains left on the ground after picking up.

### SUMMARY OF THE INVENTION

The present invention aims to overcome these drawbacks by proposing a mower type agricultural machine with lower weight, thus requiring low power and energy consumption.

To this end, the mower type agricultural machine of the present invention, moving in a direction of advance in a work configuration and comprising a frame carrying on one hand a cutter bar comprising cutting rotors driven in rotation around respective axes parallel to one another, and on the other hand, a belt conveyor comprising an endless belt driven in motion and guided between two rollers driven in rotation around their axis s, the belt having a conveying surface facing forward and a return surface facing back, the conveyor being arranged behind the cutter bar to collect, on the conveying surface, the harvest cut by the cutter bar and move it transversally to the direction of advance, is essentially characterized in that the axes of the conveyor's rollers are substantially parallel to the axes of the cutting rotors; in that it comprises a collecting shield, preferably rigidly fastened to the belt conveyor, extending at least partially under the latter and towards the cutter bar while being adjacent to the latter; and in that a space forming a transverse conveyor channel is provided above the collecting shield between the conveying surface of the belt and the cutter bar; and in that it comprises an upper deflector extending above the cutter bar and the conveying surface of the belt.

### BRIEF DESCRIPTION OF THE DRAWINGS

The invention will be better understood from the following description, which refers to a preferred embodiment given as a non-limiting example and explained with reference to the attached schematic drawings, in which:

FIG. 1 shows a top view of the agricultural machine of the present invention hitched by its inner end to the rear of a tractor vehicle and extending transversally to the direction of advance;

FIG. 2 shows a partial transverse cross-section view of the machine shown in FIG. 1;

FIG. 3 shows a perspective view of the machine shown in FIG. 2;

FIG. 4 shows a perspective view of the machine's belt conveyor shown in FIG. 1;

FIG. 5 shows a partial perspective view of the machine shown in FIG. 1, on the side of its inner end, seen from above;

FIG. 6 shows a three-quarter view of the machine shown in FIG. 5.

### DETAILED DESCRIPTION OF THE PREFERRED EMBODIMENTS

The figures show a mower type agricultural machine of the present invention, moving in a direction of advance A in a work configuration and comprising a frame 1 carrying on one hand a cutter bar 2 comprising cutting rotors 2a driven in rotation around respective axes 20a parallel to one another, and on the other hand, a belt conveyor 3 comprising an endless belt 3a driven in motion and guided between two rollers 3b driven in rotation around their axis 30b. At least one of the rollers' 3b rotation is powered by a drive means 3c. The belt 3a has a conveying surface 30a facing forward and a return surface 31a facing back. The conveyor 3 is arranged behind the cutter bar 2 to collect the harvest cut by the cutter bar 2 on the conveying surface 30a, and move it transversally to the direction of advance A.

It is understood that the conveying surface 30a is the rectilinear portion of the belt 3a facing forward, i.e. in the direction of, or facing the cutter bar 2. The return surface 31a is the rectilinear portion of the belt 3a facing back.

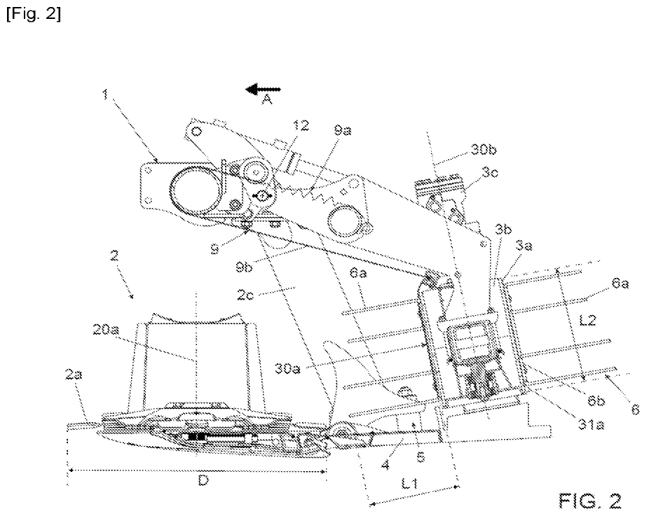

In accordance with the present invention, the axes 30b of the rollers 3b of the conveyor 3 are substantially parallel to the axes 20a of the cutting rotors 2a. It is understood that the axes 30b of the rollers 3b can be parallel to the axes 20a of the cutting rotors 2a or, as can be seen in FIG. 2, tilted forward at an angle of less than 40°, more preferably less than 25°, an even more preferably less than 10° relative to the latter.

Also in accordance with the present invention, such a machine furthermore comprises a collecting shield 4 extending at least partially under the belt conveyor 3 and towards the cutter bar 2 and being adjacent to the latter. A space forming a transverse conveyor channel 5 is provided above the collecting shield 4 between the conveying surface 30a of the belt 3a and the cutter bar 2. The collecting shield 4 is fastened to the belt conveyor 3, preferably rigidly.

Preferably, the collecting shield 4 extends between the rear of the cutter bar 2 and the conveying surface 30a of the belt 3a.

Collecting shield 4 adjacent to the cutter bar 2 means a collecting shield 4 joined to, in contact with, close to, juxtaposed with or rigidly fastened to the cutter bar 2.

Because the collecting shield 4 is adjacent to the cutter bar 2, i.e. adjacent to the rear of the latter, no additional (conditioning) device is required to transfer the harvest between the cutting rotors 2a and the conveyor 3 with no risk of loss or soiling of the harvest. In contrast to known belt conveyor mowers, whose roller axes are oriented substantially horizontally, the machine according to the invention has no conditioning device that lifts up the harvest from the cutter bar 2 towards the belt of the conveyor. Furthermore, joining or juxtaposing the cutter bar 2 to the conveyor 3 makes it possible to reduce the machine's dimensions along the direction of advance A, thus making the machine easier to manoeuvre in work and transport configurations. As can be seen particularly in FIG. 2, each cutting rotor 2a comprises a disc and at least two knives, each being mounted such that it can pivot on the disc around an axis substantially parallel to the axis 20a of the respective cutting rotor 2a. Preferably, the collecting shield 4 is located, in side view, between the support surface of the cutter bar 2 and the cutting plane going through the knives of the cutting rotors 2a and oriented perpendicular to their axes 20a.

A belt 3a, driven in motion and guided between two rollers 3b driven in rotation around axes 30b parallel to the axes 20a of the cutting rotors 2a, makes it possible, by means of its conveying surface 30a, to prevent the harvest from entering between the conveying surface 30a and the return surface 31a and consequently prevent a potential coiling of the plants contained in the harvest around the rollers 3b. In addition, when the harvest flow generated by the cutting rotors 2a comes into contact with the conveying surface 30a of the belt 3a, it is directly driven laterally, with the harvest consequently being less bunched, making it possible to achieve more uniform swaths and more regular drying. Preferably, the conveying surface 30a represents over 50%, more preferably over 75% of the rear wall of the conveyor channel 5.

Furthermore, the collecting shield 4 is oriented substantially horizontally to prevent the harvest sliding towards the cutting rotors 2a, and to make the grasping and drive of the harvest by the conveying surface 30a of the belt 3a and its feeder elements 6a easier. Preferably, the angle formed by the collecting shield 4 and the plane containing the axes 20a of the cutting rotors 2a is between 5 and 20° and more preferably between 10 and 15°.

Preferably, the mower type agricultural machine is hitched to a carrier or tractor vehicle V via a coupling device 13. The lateral end of the conveyor 3 located nearest the coupling device 13 is its inner end. The rollers 3b are located at the ends of the conveyor 3. The belt 3a could however also be guided by at least one additional roller.

The conveyor 3 can be configured to be able to change from an active or functioning position to a non-functioning retracted position. In the active or functioning position, the axes 30b of the rollers 3b of the conveyor 3 are, as previously described, substantially parallel to the axes 20a of the cutting rotors 2a. In the non-functioning retracted position, the rear of the cutting rotors 2a is clear, preferably at least over a height equal to the width L2 of the belt 3a. To change from the retracted position to the active position, the conveyor 3 is preferably swiveled around a substantially horizontal retraction axis 12.

In a preferential embodiment, such a machine also comprises a feeder device 6 fastened on the outer surface of the belt 3a, thus being rigidly attached in motion to the latter. The feeder device 6 comprises feeder elements 6a elongated in shape and fastened on the belt 3a. Preferably, the feeder elements 6a are fastened on the belt 3a at one of their ends, called “fastening end”. The free end of a feeder element 6a is the one farthest from the belt 3a. These feeder elements 6a extend over a predefined length L1 in projection on a vertical plane and parallel to the direction of advance A. They extend transversally to the outer surface. Preferably, the feeder elements 6a extend orthogonally to the plane passing through the axes 30b of the rollers 3b, at least at their fastening ends. The feeder elements 6a are preferably distributed over the entire length of the loop formed by the endless belt 3a. The collecting shield 4 is preferably located below the feeder elements 6a of the conveying surface 30a.

The length L1 of each feeder element 6a is determined along a projection of the feeder element 6a on a plane perpendicular to the axes 30b of the rollers 3b.

It is understood that in the event the present invention provides for the feeder elements 6a to extend orthogonally to the plane passing through the axes 30b of the rollers 3b, they are, taking into account the motion of the belt 3a, feeder elements 6a located on the conveying surface 30a of the belt 3a, or on the return surface 31a (parallel to the conveying surface).

Due to the orientation of the axes 30b of the rollers 3b of the conveyor 3, which is substantially parallel to the axes 20a of the cutting rotors 2a, and to the orientation of the feeder elements 6a, which is transverse to the outer surface of the endless belt 3a or at least partially parallel to the direction of advance A, the conveyor 3 does not drive the harvest downwards. The crop is therefore not swept back towards the cutting rotors 2a. The risk of harvest backflow ahead of the cutting rotors 2a, i.e. that the rotors drive the harvest forward again, is therefore lowered. The quality of the cut is then improved. In addition, such a conveyor 3 does not lead to the swath twisting and enables an easier management of the intake speed of the pick-up machine equipped, for example, of a pick-up device, i.e. a front pick-up device with raking fingers driven in rotation along a horizontal axis.

Preferably, each feeder element 6a can consist of a rod that is thin, narrow or filiform over all or part of its length L1, at least at its free end. In particular, each feeder element 6a can have a circular cross-section at its free end, with a diameter between 5 to 25 millimeters for example. The effect of this feature is to further open the feeder device 6 in the conveyor channel 5 and thus has the advantage of significantly reducing any ventilation effect that might be generated by such feeder elements 6a without this feature and which would tend to move the harvest away from the conveyor 3, reducing its ability to grasp and risking to cause a harvest backflow towards the front of the cutting rotors 2a. In this way, the use of feeder elements 6a shaped as thin, narrow or filiform rods makes it possible to improve the cutting quality.

In this type of agricultural machine, the outer path of each cutting rotor 2a has a predefined diameter D.

The length L1 of at least one feeder element 6a is at least one-eighth the diameter D of the outer path of a cutting rotor 2a. Preferably, the length L1 of at least one feeder element 6a is at least one-sixth, more preferably at least one-quarter, and even more preferably at least one-half the diameter D of the outer path of a cutting rotor 2a. Preferably, the length L1 of most of the feeder elements 6a is greater than one-eighth, more preferably one-sixth, even more preferably one-quarter, and yet more preferably one-half, the diameter D of the outer path of a cutting rotor 2a. The advantage of this length feature is that, for a constant rotation speed, the longer the feeder elements 6a, the greater the ejection force of the harvest, since the tangential speed increases along with the radius, consequently making it possible to deposit the harvest at a laterally greater distance, providing greater flexibility as to the location of the swath. Furthermore, the longer the feeder elements 6a, the greater the quantity of harvest driven. Another advantage is that the conveyor channel 5 can have a greater cross-section, thus reducing or avoiding the risk of jamming in the conveyor channel 5, which requires manual intervention and consequently slows down the agricultural work. Similarly, the dimension of the diameter D of the outer path of a cutting rotor 2a is decisive insofar as the larger it is, the greater the harvest's rearward ejection force provided by the cutting rotors 2a.

According to an additional feature, the feeder element(s) 6a located at the lowest location of the conveying surface 30a has (have) a predefined length L1 such that the free end of this (these) lowest feeder element(s) 6a of the conveying surface 30a is located near the rear end of the cutter bar 2 or of the cutter rotors 2a. Preferably, the lowest feeder element(s) 6a is (are) located, in projection on a plane parallel to the direction of advance A and perpendicular to the axes 20a of the cutting rotors 2a, relative to the rear end of the cutter bar 2 or of the cutting rotors 2a, at a distance less than 5 centimeters and preferably less than 2 centimeters. Also, the feeder elements 6a whose free ends are closest to the cutting rotors 2a are located, in projection on a vertical plane and parallel to the direction of advance A, at a distance from the cutting rotors 2a less than one-third the diameter D of the outer path of a cutting rotor 2a. Preferably, the lowest feeder elements 6a of the conveying surface 30a are located, in projection on a plane parallel to the direction of advance A and to the axes 20a of the cutting rotors 2a, at a distance from the cutting rotors 2a less than one-sixth, more preferably less than one-eighth, the diameter D of the outer path of a cutting rotor 2a, respectively of the smallest cutting rotor 2a, where applicable. The advantage of this proximity feature, which leads to a small dead zone, is that it generates a low risk of the harvest accumulating between the cutter bar 2 and the conveyor 3. Such a harvest accumulation may lead to the conveyor 3 depositing the harvest where it is not wanted, and/or to the swath being incorrectly positioned. The fact that the accumulation of harvest between the cutter bar 2 and the conveyor 3 is prevented makes it possible to prevent the harvest flow from the cutting rotors 2a being slowed down and to prevent the formation of packets, resulting in a more uniform swath, which is therefore easier to harvest and/or whose drying is more regular, leading to higher quality fodder. In addition, due to the relatively large length L1 of at least some of the feeder elements 6a, the cross-section of the conveyor channel 5 remains large, with a lower risk of jamming.

The reduced extent of the dead zone between the cutter bar 2 and the conveyor 3 can also be characterized by describing the proportion of the zone located between the rotors 2a and the conveying surface 30a covered by the feeder elements 6a. As can be seen in FIG. 5 in particular, over 60% of the zone that extends from the rear of the rotors 2a to the conveying surface 30a are thus covered by the feeder elements 6a. In the preferred embodiment, over 75%, more preferably over 90% of the zone extending from the rear of the rotors 2a to the conveying surface 30a are covered by the feeder elements 6a. Due to this proximity of the conveyor 3 to the cutter bar 2 and to the harvest flow generated by the rotation of the rotors 2a, the harvest cannot accumulate, or accumulates less in this zone, thus preventing the formation of packets and irregular transport of the crop. The resulting swaths are then more regular and drying more uniform.

FIG. 5 also shows that the conveying surface is substantially perpendicular to the direction of advance A in a view following the axes 30b of the rollers 3b, to prevent stationary harvest accumulation, slowing down the harvest flow, and possibly causing the harvest to be transported in packets, which, when they reach the conveyor 3, lead to irregular swaths and heterogeneous drying of the harvest. Too great an accumulation of stationary harvest can also cause jams inside the conveyor channel 5, requiring inconvenient additional interventions.

In one example embodiment variant, not shown, the conveying surface 30a forms an angle of less than 90° to the direction of advance A, in a view following the axes 30b of the rollers 3b. In this case, the distance between the lowest feeder elements 6a of the conveying surface 30a and the cutting rotors 2a to be take in consideration is the average of all the feeder elements 6a of the conveying surface 30a. According to another variant not shown, the paths D of the cutting rotors 2a are located between two lines of feeder elements 6a, in side view.

The conveyor 3 can thus be arranged directly behind the cutter bar 2 as the machine 1 comprises no roller driven around a horizontal axis to drive the crop in the direction opposite to the direction of advance (A). Indeed, no device, additional or not, except for the cutting rotors 2a, drives the harvest in the direction opposite the direction of advance A. In particular, no roller is mounted between the cutter bar 2 and the conveyor 3. Indeed, such a device is not required, due to the length L1 of at least some feeder elements 6a, to the driving of the cutting rotors 2a and to the proximity of the rotors 2a with the, or at least some of the feeder elements 6a. Not having to use such a device makes it possible to make the machine lighter and shorter along the direction of advance A. Lastly, one advantage of a conveyor 3 comprising a belt 3a according to the invention, versus a conveyor with a roller(s) driven around an axis transverse to the direction of advance A, is that the long plants contained in the harvest do not tend, or tend less, to wind around the roller(s), preventing friction and increased energy consumption linked to this friction, or even blocking of the rotation of the roller(s), which can lead to significant damage and lost time for repairing.

According to another additional feature, the present invention can provide that at least one-third, preferably one-half of the length L1 of a feeder element 6a forms an angle of approach of less than 90°, preferably less than 75° with the belt 3a in a view along the axes 30b of the rollers 3b. The advantage of this feature is that it thus reduces the portion of the harvest that is driven at the rear of the belt 3a, with no articulation of the feeder elements 6a to the belt 3a. Indeed, the portion of the harvest driven at the return surface 31a risks to be deposited behind the machine, reducing the quality of the work, and leading to loss of harvest.

In a preferred example embodiment of the layout or arrangement of the feeder elements 6a on the belt 3a, the latter are arranged on the outer surface 30 of the belt 3a in rows extending parallel to the axes 30b of the rollers 3b. The feeder elements 6a on a single row extend preferably over most of the width L2 of the belt 3a. Preferably, the feeder elements 6a of the belt 3a are also distributed along at least three lines that are horizontal or parallel to the ground, and preferably over four lines, making it possible to properly drive the harvest and thus prevent jams.

In a preferred example embodiment of the feeder device 6 making it possible to fasten more solidly the feeder elements 6a on the belt 3a, while providing them with flexibility, the feeder device may comprise a plurality of fixing supports 6b, preferably each having the form of a pall. The or each fixing support 6b is preferably elongated and fastened on the outer surface of the belt 3a and may extend over all or practically all the width L2 of the belt 3a. The or each fixing support 6b is preferably made of the same material as the belt 3a. Each row of feeder elements 6a can then comprise one of the fixing supports 6b. The feeder elements 6a are then fastened, at their fastening end, to the belt 3a with the respective fixing supports 6b. The thickness of each fixing support 6b can preferably be greater than four times the thickness of the belt 3a to provide increased strength to the fastening of the feeder elements 6a to the belt 3a.

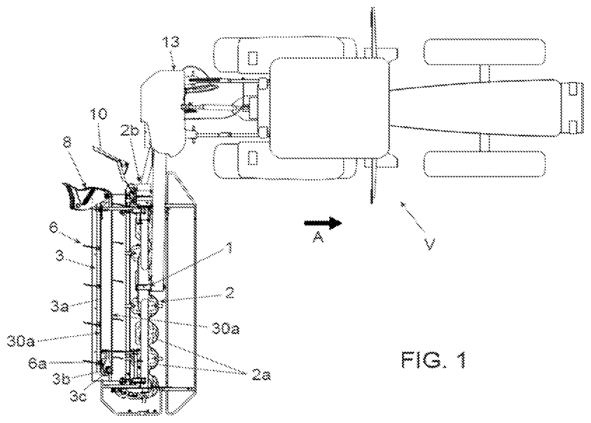

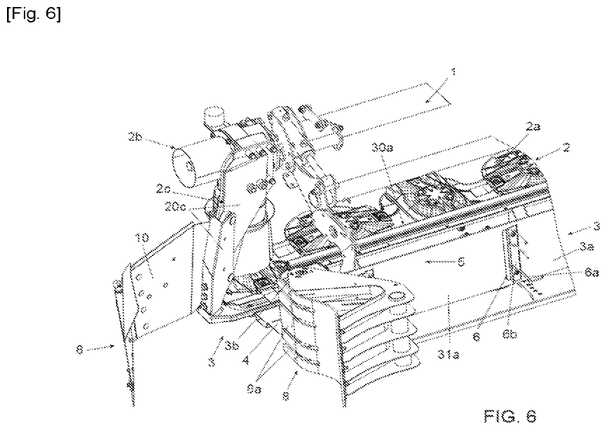

Preferably, as can be seen in FIGS. 1, 5 and 6, the agricultural machine of the present invention may also comprise a comb 8 extending along an axis substantially parallel to the axes 30b of the rollers 3b of the conveyor 3, at least partially rearward of the rollers 3b of the conveyor 3 and at the location of the inner end of the conveyor 3. The comb 8 comprises tines 8a in the shape of straight or curved blades. Preferably, the tines 8a extend mainly along the direction of advance A. The tines 8a are spaced apart from one another along the direction of the axes 30b of the rollers 3b of the conveyor 3. Such spacing between the tines makes it possible to let the feeder elements 6a pass between the tines 8a during the movement of the belt 3a. The advantage of such a comb 8 is that it prevents the harvest from being deposited at the rear of the conveyor 3, thus preventing or reducing the loss of fodder, with no articulation of the feeder elements 6a and the belt 3a. In an alternative embodiment, not shown, to prevent any harvest being snagged at the location of the tines 8a, the comb 8 can also be driven in rotation around an axis parallel to the axis 30b of the rollers 3b. Preferably, to prevent the harvest being driven at the rear of the belt 3a, the comb 8 is driven in rotation in the opposite direction to the rollers 3b.

Preferably, to achieve reduced dimensions, a lower weight, and a lower power requirement to drive the belt 3a, the width L2 of the belt 3a is less than three-quarters of the diameter D of the outer path of a cutting rotor 2a. Preferably, the width L2 of the belt 3a is less than two-thirds, more preferably substantially equal to half the diameter D of the outer path of a cutting rotor 2a. It is understood that the width L2 of the belt 3a is its dimension along the axes 30b of the rollers 3b of the conveyor 3. In other words, the width L2 is the same as height of the belt 3a.

Preferably, to achieve a faster drive of the belt 3a or to further avoid or limit jamming problems, the width L2 of the belt 3a is greater than one-quarter of the diameter D of the outer path of a cutting rotor 2a. Preferably, the width L2 of the belt 3a is greater than one-third of the diameter D of the outer path of a cutting rotor 2a.

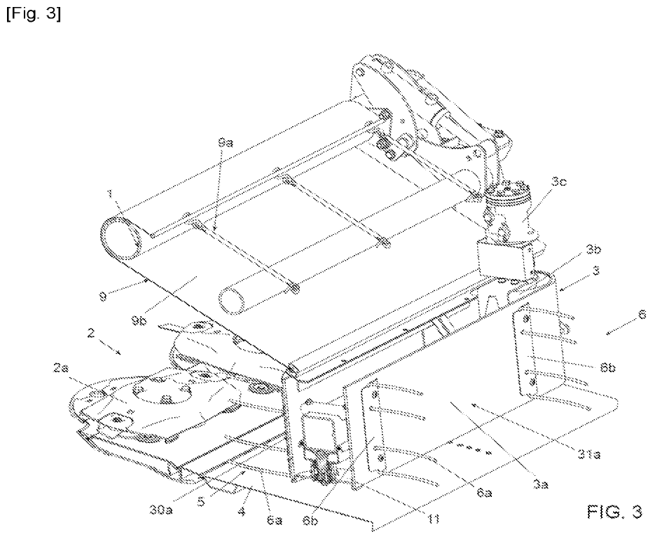

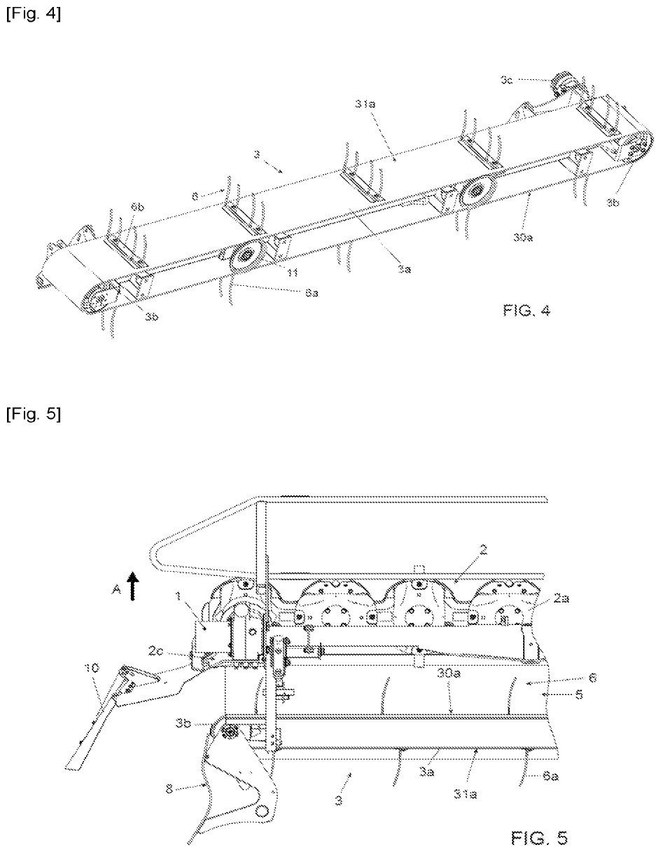

On the other hand, with particular reference to FIGS. 2 and 3, to reduce the harvest losses while keeping the intrusion of plants between the rollers 3b of the conveyor 3 to a minimum, the present invention may provide for the agricultural machine to also comprise an upper deflector 9 extending above the cutter bar 2 and above the conveying surface 30a of the belt 3a. More specifically, the conveyor channel 5 is bounded at the bottom by the collecting shield 4, at the front by the cutting rotors 2a, at the back by the conveying surface 30a of the belt 3 and at the top by the deflector 9. Channeling the harvest in this way, after it has been ejected by the cutting rotors 2a, makes it possible to prevent harvest losses and to keep clean, firstly the plot on which the harvest is mowed, and secondly the space between the conveying surface 30a and return surface 31a.

In a preferred example embodiment of the upper deflector 9, the latter can comprise extending means 9a at least along a direction parallel to the direction of advance A. The extending means 9a are preferably connected to the frame 1. Therefore, the deflector 9 should not be removed when the conveyor 3 switches between the active and retracted positions. It is preferably made or consists of flexible cloth 9b.The upper deflector 9 preferably extends over the entire length, or at least most of the length of the conveyor 3.

On the other hand, as can be seen in FIGS. 1 and 2 in particular, in order to make the rotation speed of the belt 3a of the conveyor 3 vary, with a control, separately from that of the cutting rotors 2a and without requiring the elements making up the agricultural machine, such as the conveyor 3, to be removed, the present invention can provide that the drive means 3c of the conveyor 3 is separate from the drive means 2b of the cutter bar 2. The control can be located on the agricultural machine or preferably on the carrier or tractor vehicle V to which the agricultural machine is connected. The drive means 2b of the cutter bar 2a may be, as is generally the case in known machines, the power take-off of the vehicle V linked to the cutter bar 2a by a driveline comprising telescopic shafts and/or cardan shafts. However, the drive means 2b of the cutter bar 2a could also be a hydraulic motor, whose pressurized oil source comes from the carrier or tractor vehicle V.

The cutter bar 2 comprises two opposite ends between which it extends, i.e. an inner end and an outer end, which is further away from the hitching device 13. Furthermore, in a preferred embodiment of the cutter bar 2, the latter is suspended on the frame 1 by means of legs 2c. At least one inner leg 2c is located near the inner end. Preferably, the cutter bar 2 is also suspended on the frame 1 by an outer leg located near the outer end. On the other hand, the inner leg 2c may comprise an inner surface 20c oriented between 30° and 60°, preferably about 45°, relative to the direction of advance A. Because this inner surface 20c is substantially tangential to the path of the free ends of the feeder elements 6a, it takes part in guiding the harvest flow, thus preventing harvest strands getting entangled on this inner leg 20c and, after accumulation, reducing the output cross-section of the conveyor channel 5. This reduction of the conveyor channel may lead to depositing the harvest where it is not wanted, and/or to incorrect positioning of the swath. Due to the orientation of this inner surface 20c, the inner leg 2c both provides the structural support for the cutter bar 2 and makes it possible to guide the harvest flow and thus improve its positioning relative to the conveyor 3.

With reference to FIGS. 1, 5 and 6, one can see that the present invention can also provide for the agricultural machine to also comprise a swath shield 10. Such a shield 10 extends laterally relative to the cutter bar 2a, preferably substantially at 45° to the direction of advance A. Preferably, the shield 10 can extend on either side of the inner leg 2c, making it possible to prevent fodder losses from the inner cutting rotor 2a and to calibrate the swath. At least one portion of the shield 10 can be oriented relative to the direction of advance A, making it possible to move the location of the swath orthogonally to the direction of advance A.

In addition, with particular reference to FIG. 3, one can see that, to support the belt 3a, particularly by its edge, the agricultural machine can preferably also comprise at least one guiding element 11 located below the belt 3a. Preferably, the guiding element 11 is in contact with the belt 3a in order to guide it. The guiding element 11 preferably supports the conveying surface 30a and the return surface 31a. As shown in FIG. 3, the guiding element 11 can preferably be located above the collecting shield 4 when the latter extends rearward to the return surface 31a. The or each guiding element 11 can be designed to be guided in rotation around an axis substantially parallel to the axes 30b of the rollers 3b of the conveyor 3. In this way, there is less risk of the belt 3a rubbing against the collecting shield 4, on any other part located under the belt 3a and/or on the ground, consequently leading to less wear of the belt 3a and a lower power requirement.

Preferably, the belt 3a is flexible. Furthermore, preferably, the belt 3a, called non-perforated belt 3a, has no openings or practically no openings, unlike a chain or certain belts whose structure itself is perforated. This feature makes it possible to avoid installing an additional collecting shield at the rear, i.e. behind the belt 3a. In this way, at least the conveying surface 30a of the belt 3a constitutes a means of retention for the harvest, preventing losses. Another advantage is that the non-perforated belt 3a makes it possible to reduce soiling of the drive means 3c of at least one of the rollers 3b of the conveyor 3, thus leading to less maintenance being required.

Of course, the invention is not limited to the example embodiment described and shown in the attached drawings. Modifications remain possible, in particular concerning the composition of the various elements or by substituting technical equivalents without departing from the scope of protection of the invention.

1. A mower type agricultural machine moving in a direction of advance in a work configuration and comprising a frame carrying on one hand a cutter bar comprising cutting rotors driven in rotation around respective axes parallel to one another, and on the other hand, a belt conveyor comprising an endless belt driven in motion and guided between two rollers driven in rotation around their axis , the belt having a conveying surface facing forward and a return surface facing back, the conveyor being arranged behind the cutter bar to collect the harvest cut by the cutter bar on the conveying surface, and move it transversally to the direction of advance, wherein the axes of the rollers of the conveyor are substantially parallel to the axes of the cutting rotors, the machine further comprising a collecting shield fastened to the belt conveyor and extending at least partially under the belt conveyor and towards the cutter bar while being adjacent to the cutter bar, a space forming a transverse conveyor channel is provided above the collecting shield between the conveying surface of the belt and the cutter bar, and the agricultural machine furthermore comprises an upper deflector extending above the cutter bar and above the conveying surface of the belt.

2. The agricultural machine of claim 1, further comprising a feeder device fastened on the outer surface of the belt, thus being rigidly attached in motion to the latter, the feeder device comprising feeder elements elongated in shape and fastened on the belt and extending over a predefined length in projection on a vertical plane and parallel to the direction of advance.

3. The agricultural machine of claim 2, wherein the length of at least one feeder element is at least one-eighth the diameter of the outer path of a cutting rotor.

4. The agricultural machine of claim 2, wherein over 60% of the zone that extends from the rear of the rotors to the conveying surface is covered by the feeder elements.

5. The agricultural machine of claim 1, wherein the conveying surface is substantially perpendicular to the direction of advance in a view along the axes of the rollers.

6. The agricultural machine of claim 1, wherein the conveyor channel is bounded at the bottom by the collecting shield, in front by the cutting rotors, at the rear by the conveying surface of the belt and at the top by the deflector.

7. The agricultural machine of claim 1, wherein the conveying surface represents over 50%, more preferably over 75% of the rear wall of the conveyor channel.

8. The agricultural machine of claim 2, wherein each feeder element consists of a rod that is thin, narrow or filiform over all or part of its length, at least at its free end.

9. The agricultural machine of claim 2, further comprising a comb extending along an axis substantially parallel to the axes of the rollers of the conveyor, at least partially rearward of the rollers of the conveyor and at the location of the inner end of the conveyor, the comb comprising tines in the shape of blades spaced apart from each other along the direction of the axes of the rollers of the conveyor.

10. The agricultural machine of claim 1, wherein the cutter bar is suspended on the frame by means of legs, at least one inner leg being located near the inner end of the cutter bar; and the inner leg comprises an inner surface oriented between 30° and 60° relative to the direction of advance.

11. The agricultural machine of claim 1, further comprising at least one guiding element located under the belt and guided in rotation around an axis substantially parallel to the axes of the rollers of the conveyor.

12. The agricultural machine of claim 1, wherein the width of the belt is less than three quarters the diameter of the outer path of a cutting rotor.

13. The agricultural machine of claim 1, wherein the width of the belt is greater than one-quarter of the diameter of the outer path of a cutting rotor.

14. The agricultural machine of claim 1, wherein the conveyor is arranged directly behind the cutter bar and which comprises no roller driven around a horizontal axis to drive the harvest in the direction opposite to the direction of advance.

15. The agricultural machine of claim 9, wherein the upper deflector comprises extending means , at least along a direction parallel to the direction of advance, connected to the frame.
